(19) United States
(12) Patent Application Publication
(10) Pub. No.: US 2020/0255354 A1
(43) Pub. Date: Aug. 13, 2020

(54) Organic Fertiliser and Soil Improver Comprising Keratin

(71) Applicant: Veratin Pty Ltd, Balcatta (AU)

(72) Inventor: Ramiz Boulos, Balcatta (AU)

(21) Appl. No.: 16/326,795

(22) PCT Filed: Aug. 14, 2017
(86) PCT No.: PCT/AU2017/000165

§ 371 Date: Feb. 20, 2019

(30) Foreign Application Priority Data
Sep. 1, 2016 (AU) 2016903498

(51) Int. Cl. C05F 1/00

(52) U.S. Cl. CPC C05F 1/005

(57) ABSTRACT

The present invention relates to a fertiliser and/or soil improver, for use in enhancing the growth of plants, comprising keratin, preferably obtained from wool. Also described is a method of enhancing the growth of plants using a fertiliser and/or soil improver comprising keratin.

### FIELD OF THE INVENTION

The present invention relates to an organic fertiliser and soil improver. More specifically, the present invention relates to an organic protein as a source of nitrogen for use as a fertiliser and/or soil improver.

### BACKGROUND

Fertilisers and soil improvers are commonly used in the agricultural industry and even by home gardeners, and indeed fertilisers and soil improvers have many applications and uses between the two. The growth of plants can be enhanced with the use of fertilisers by providing nutrients for uptake by the plant and with the use of soil improvers by enhancing the effectiveness of the soil in which the plant grows. The nutritional aspect of fertilisers and soil improvers can involve the provision of one or more of the three main macronutrients, nitrogen, phosphorus and potassium, for various growth enhancement activity.

Most common fertilisers and soil improvers are synthetic or inorganic. Usually, various chemical treatments are required for their manufacture. Inorganic fertilisers and soil improvers commonly achieve greater results when applied to plants and soil, compared with natural or organic fertilisers and soil improvers. However, organic fertilisers and soil improvers are often favoured, for myriad reasons, not the least of which include environmental concerns. Accordingly, there exists the need to identify new, effective, organic fertilisers and soil improvers.

Traditionally, it was believed that nitrogen naturally occurring in soil as proteins was not directly available to plants. Rather, the view was that plants relied on microbes and soil fauna for the breakdown of organic material for their use. However, it has recently been shown that roots are able to directly access protein, likely through either enzymatic digestion using proteolytic enzymes exuded from the plant's own roots or through root uptake via endocytosis (see PNAS, 2008, 105:11, 4524).

Further, wool, as a protein source, is available in abundance and huge amounts of otherwise unusable wool is regularly discarded. Useful repurposing of wool therefore results in both economic and environmental advantages.

The present invention attempts to overcome at least in part the aforementioned disadvantages of previous fertilisers and soil improvers.

### SUMMARY OF THE INVENTION

In accordance with one aspect of the present invention there is provided a fertiliser and/or soil improver, for use in enhancing the growth of plants, comprising keratin.

One or more of the following plant growth parameters may be enhanced: plant height, biomass, normalised difference vegetation index (NDVI), root weight, foliage weight and total plant weight.

The keratin may be obtained from wool. The keratin may be obtained through deconstruction of wool using a eutectic melt.

The eutectic melt may comprise choline chloride and urea. The choline chloride and urea mixture may be heated. A molar ratio of choline chloride to urea may be from about 20:1 to about 1:20.

The deconstruction of the wool using the eutectic melt may involve heating. A weight to volume ratio of wool to eutectic melt may be from about 1 g:1 ml to about 1 g:100 ml.

In accordance with a second aspect of the present invention there is provided a method of enhancing the growth of plants using a fertiliser and/or soil improver comprising keratin.

The method may enhance one or more of the following plant growth parameters: plant height, biomass, normalised difference vegetation index (NDVI), root weight, foliage weight and total plant weight.

The method of enhancing the growth of plants may comprise the use of the fertiliser and/or soil improver comprising keratin as an additive to a known fertiliser and/or soil improver.

The method may comprise multiple, separate applications of the fertiliser and/or soil improver comprising keratin to the plants.

An application of the fertiliser and/or soil improver comprising keratin may be as a liquid to a surface of soil, proximal to a location of the plant within that soil.

### BRIEF DESCRIPTION OF DRAWINGS

The present invention will now be described, by way of example, with reference to the accompanying drawings, in which:

FIG. 1 is a graph displaying the plant height results according to Example I;

FIG. 2 is a graph displaying the plant biomass results according to Example I;

FIG. 3 is a graph displaying the NDVI results according to Example I;

FIG. 4 is a graph displaying the foliage weight results according to Example I;

FIG. 5 is a graph displaying the root weight results according to Example I; and

FIG. 6 is a graph displaying the total plant weight results according to Example I

### DESCRIPTION OF PREFERRED EMBODIMENT

Keratin is a fibrous structural protein naturally occurring in epithelial cells. There are two varieties of keratin fibres, being α-keratins found in hair and wool etc. and β-keratins, which are harder and are found in such material as nails and beaks. Being a protein, keratin comprises nitrogen from the amino acids which form its structure. The activity of nitrogen on plant growth is well known.

It has presently been found that compositions comprising the keratin protein, and more specifically keratin from wool extracts, possess marked biological stimulant activity and have consequently proved effective as an organic nitrogen source and hence a fertiliser and/or soil improver, or an additive to a fertiliser and/or soil improver, for enhanced plant growth.

According to the invention, wool from sheep is deconstructed to obtain the keratin protein available for uptake by plants. This wool extract has demonstrated fertiliser and/or soil improver activity itself or as an additive to fertiliser and/or soil improver.

The preparation of this extract comprises fabrication of keratin through deconstruction of sheep's wool using a benign choline chloride-urea deep eutectic solvent melt. The eutectic melt is formulated by mixing choline chloride and urea at a molar ratio of between about 20:1 and 1:20 while heating for a number of minutes. Wool is then dissolved in the eutectic melt at a weight to volume ratio of between about 1 g:1 ml and about 1 g:100 ml using heat. Processing wool in this way does not destroy the organic content of the material. (The method of preparation reflects that of RSC Adv., 2016, 6, 20095.)

The heating step of the above process would be understood by the skilled person to cause conversion of at least some of the urea content to ammonia. The resultant ammonia gas escapes to the atmosphere, thereby reducing the nitrogen content of the mixture. A pungent smell is also observable, due to the presence of this ammonia.

The following example illustrates the effectiveness of the invention.

### Example I—Biological Activity

The composition according to the invention was tested on potted Grosse Lisse tomatoes to evaluate plant growth. Treatments applied were Verigrow-1: choline chloride+urea, without heating; Verigrow-2: choline chloride+urea, with heating; and Verigrow-3: choline chloride+urea+wool, with heating; each prepared as 1:10 dilutions with water and at 5.4, 10.8 and 21.6 mL/plant (pot); as well as a commercially available seaweed plant treatment (Seasol®) at 141.3 mL/plant. Treatments were applied as either a double application, at transplanting (3-4 leaves on main stem) and 29 days later at 50% inflorescence emergence, or as a single application at 50% inflorescence emergence. The chronology of events and treatments are shown below in Tables 1 and 2 respectively.

TABLE 1
Chronology of events.

| | Days after | | | |
|---|---|---|---|---|
| | application | Crop stage | | |
| Date | A&B | BBCH scale | Description | Event |
| 6 Dec. 2016 | −1 | 13-14 | 3 to 4 leaves on the main | Seedlings transplanted into |
| | −30 | | stem | pots |
| 7 Dec. 2016 | 0 | 13-14 | 3 to 4 leaves on the main | Application A |
| | −29 | | stem | |
| 21 Dec. 2016 | 14 | 14-16 | 4 to 6 leaves on the main | Plant height, biomass and |
| | −15 | | stem | NDVI assessments |
| 3 Jan. 2017 | 27 | 15-55 | 5 leaves on main stem to | Plant height, biomass and |
| | −2 | | 50% inflorescence emerged | NDVI assessments |
| 5 Jan. 2017 | 29 | 15-55 | 5 leaves on main stem to | Application B |
| | 0 | | 50% inflorescence emerged | |
| 11 Jan. 2017 | 35 | 15-61 | 5 leaves on main stem to | Plant height, biomass and |
| | 6 | | start of flowering | NDVI assessments |
| 18 Jan. 2017 | 42 | 15-63 | 5 leaves on main stem to | Plant height, biomass and |
| | 13 | | 30% of flowers open | NDVI assessments |
| 1 Feb. 2017 | 56 | 16-65 | 6 leaves on main stem to | Plant height, biomass and |
| | 27 | | 50% of flowers open | NDVI assessments |
| 7 Feb. 2017 | 62 | 16-65 | 6 leaves on main stem to | Plant weight assessment |
| | 33 | | 50% of flowers open | |

TABLE 2
Treatments (Verigrow formulations: 150 mL/1.5 L of
water; seaweed treatments: 6.67 mL/2 L of water).

| | | Rate | | |
|---|---|---|---|---|
| | | | Active | |
| | | Diluted mix | ingredient | Application |
| No. | Treatment | (mL/200 mm pot) | (mL/pot) | schedule |
| 1 | Verigrow-1 | 5.4 | — | AB |
| 2 | Verigrow-1 | 10.8 | — | AB |
| 3 | Verigrow-1 | 21.6 | — | AB |
| 4 | Verigrow-2 | 5.4 | — | AB |
| 5 | Verigrow-2 | 10.8 | — | AB |
| 6 | Verigrow-2 | 21.6 | — | AB |
| 7 | Verigrow-3 | 5.4 | — | AB |
| 8 | Verigrow-3 | 10.8 | — | AB |
| 9 | Verigrow-3 | 21.6 | — | AB |
| 10 | Verigrow-1 | 5.4 | — | B |
| 11 | Verigrow-1 | 10.8 | — | B |
| 12 | Verigrow-1 | 21.6 | — | B |
| 13 | Verigrow-2 | 5.4 | — | B |
| 14 | Verigrow-2 | 10.8 | — | B |
| 15 | Verigrow-2 | 21.6 | — | B |
| 16 | Verigrow-3 | 5.4 | — | B |
| 17 | Verigrow-3 | 10.8 | — | B |
| 18 | Verigrow-3 | 21.6 | — | B |
| 19 | Untreated | nil | nil | — |
| | control | | | |
| 20 | Untreated | nil | nil | — |
| | control | | | |
| 21 | Seaweed | 141.3 | — | AB |
| | treatment | | | |
| 22 | Seaweed | 141.3 | — | B |
| | treatment | | | |

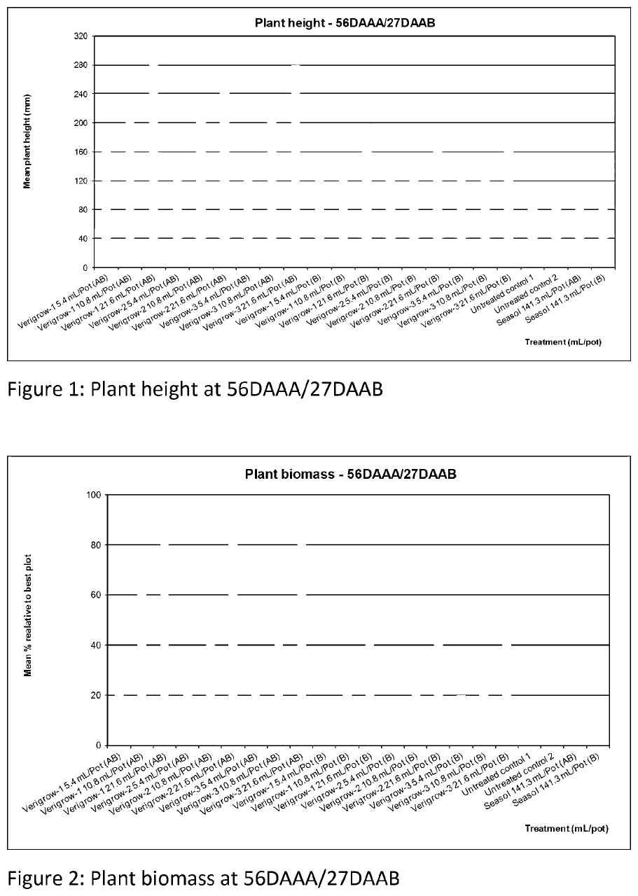

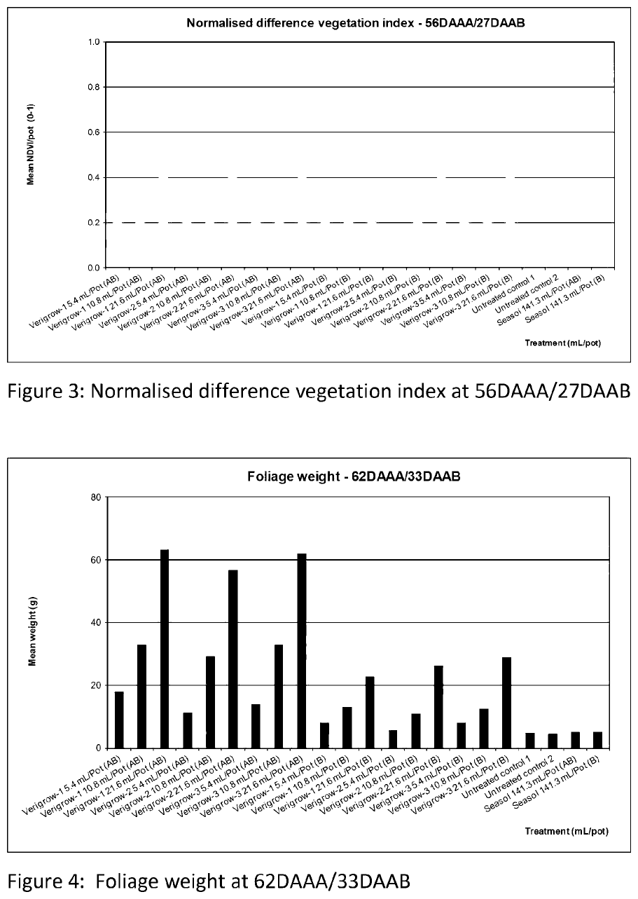

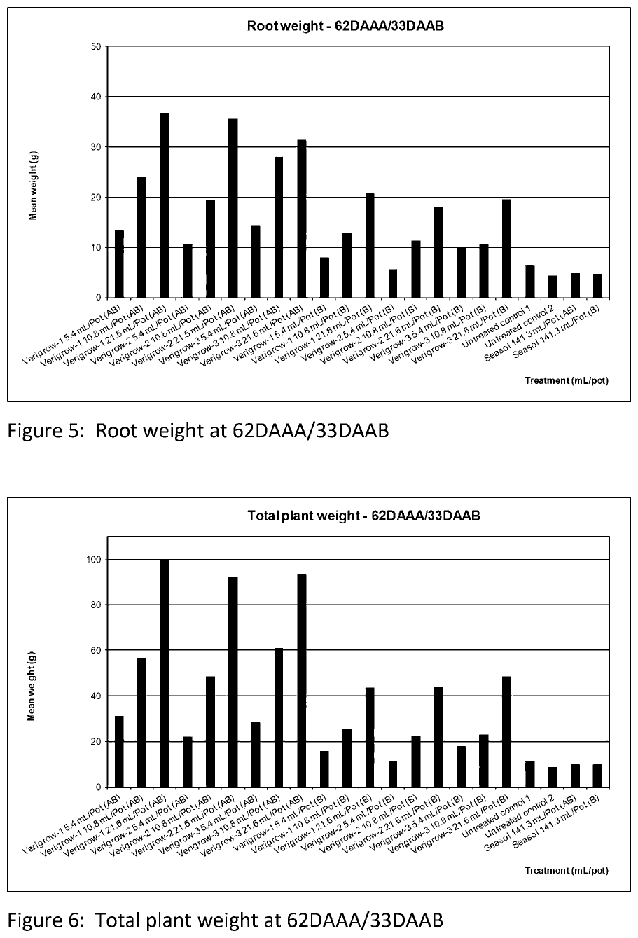

The results are shown in FIGS. 1 to 6 at various days after applications A or B (DAAA or DAAB).

Plant height, biomass, normalised difference vegetation index (NDVI) and weights (root and foliage) were measured and all factors were significantly increased by all three Verigrow formulations, with a significant dose response to increasing rates of all Verigrow formulations. Double applications of Verigrow formulations provided greater increases in plant height, biomass, NDVI and weights (root and foliage) than single applications. Single and double applications of the seaweed plant treatment were not significantly different to the untreated control in plant height, biomass, NDVI or weights (root and foliage).

These results confirm that nitrogen is lost through the heating of the eutectic melt, as evidenced by the superior results achieved by Verigrow-1 when compared with Verigrow-2. However, the results achieved by Verigrow-3, being the formulation comprising keratin were similar to those of the unheated mixture and hence additional nitrogen was available for the plants, despite the heating process.

As has been previously shown (see PNAS, 2008, 105:11, 4524), organic nitrogen is available to plants in the form of protein or as amino acids. The effect of treating wool according to the present invention means that the resulting keratin protein is bioavailable as an organic nitrogen source. This nitrogen can be accessed by plants through root uptake in the form of the protein itself via endocytosis, or as simpler amino acids resulting from enzymatic digestion (either by the proteolytic activity of the roots or from microbes present in the soil).

The present invention has been found to possess advantages over inorganic nitrogen sources, including a longer durability. Further, protein as a nitrogen source results in an increase in a plant's ability to develop a more extensive root network. It is understood that the keratin protein, available from the present composition through the deconstruction of wool, is bioavailable as an organic nitrogen source available to plants. The present invention additionally provides the advantages of being an avenue for reducing or eliminating wool waste and also serving as an additional income stream for wool producers.

Modifications and variations as would be apparent to a skilled addressee are deemed to be within the scope of the present invention.

1.-14. (canceled)

15. A fertiliser and/or soil improver, for use in enhancing the growth of plants, comprising keratin obtained from wool through deconstruction of wool using a eutectic melt.

16. A fertiliser and/or soil improver according to claim 15, wherein the eutectic melt comprises choline chloride and urea.

17. A fertiliser and/or soil improver according to claim 16, wherein the choline chloride and urea mixture is heated.

18. A fertiliser and/or soil improver according to claim 16, wherein a molar ratio of choline chloride to urea is from about 20:1 to about 1:20.

19. A fertiliser and/or soil improver according to claim 17, wherein a molar ratio of choline chloride to urea is from about 20:1 to about 1:20.

20. A fertiliser and/or soil improver according to claim 15, wherein the deconstruction of the wool using the eutectic melt involves heating.

21. A fertiliser and/or soil improver according to claim 18, wherein a weight to volume ratio of wool to eutectic melt is from about 1 g:1 ml to about 1 g:100 ml.

22. A fertiliser and/or soil improver according to claim 15, wherein a weight to volume ratio of wool to eutectic melt is from about 1 g:1 ml to about 1 g:100 ml.

23. A fertiliser and/or soil improver according to claim 16, wherein a weight to volume ratio of wool to eutectic melt is from about 1 g:1 ml to about 1 g:100 ml.

24. A fertiliser and/or soil improver according to claim 17, wherein a weight to volume ratio of wool to eutectic melt is from about 1 g:1 ml to about 1 g:100 ml.

25. A fertiliser and/or soil improver according to claim 18, wherein a weight to volume ratio of wool to eutectic melt is from about 1 g:1 ml to about 1 g:100 ml.

26. A fertiliser and/or soil improver according to claim 19, wherein a weight to volume ratio of wool to eutectic melt is from about 1 g:1 ml to about 1 g:100 ml.

27. A method of enhancing the growth of plants using a fertiliser and/or soil improver comprising keratin obtained from wool through deconstruction of wool using a eutectic melt.

28. A method according to claim 27, wherein one or more of the following plant growth parameters is enhanced: plant height, biomass, normalised difference vegetation index (NDVI), root weight, foliage weight and total plant weight.

29. A method according to claim 27, wherein keratin obtained from wool through deconstruction of wool using a eutectic melt, is used as an additive to a known fertiliser and/or soil improver.

30. A method according to claim 28, wherein keratin obtained from wool through deconstruction of wool using a eutectic melt, is used as an additive to a known fertiliser and/or soil improver.

31. A method according to claim 27, comprising multiple, separate applications of the fertiliser and/or soil improver comprising keratin.

32. A method according to claim 29, comprising multiple, separate applications of the fertiliser and/or soil improver comprising keratin.

33. A method according to claim 27, comprising an application of the fertiliser and/or soil improver comprising keratin as a liquid to a surface of soil, proximal to a location of the plant within that soil.

34. A method according to claim 29, comprising an application of the fertiliser and/or soil improver comprising keratin as a liquid to a surface of soil, proximal to a location of the plant within that soil.

35. A method of enhancing the growth of plants using a fertiliser and/or soil improver comprising a protein in a eutectic melt.
